(19) United States
(12) Patent Application Publication
(10) Pub. No.: US 2008/0142765 A1
(43) Pub. Date: Jun. 19, 2008

(54) Hybrid spring extender

(75) Inventors: Cordell E. Bauer, Costa Mesa, CA (US); Scott E. Poncher, Costa Mesa, CA (US)

Correspondence Address: CROCKETT & CROCKETT, 24012 CALLE DE LA PLATA, SUITE 400, LAGUNA HILLS, CA, 92653, US

(73) Assignee: ReadyLift Suspension, Inc.

(21) Appl. No.: 12/002,119

(22) Filed: Dec. 13, 2007

Related U.S. Application Data
(60) Provisional application No. 60/874,784, filed on Dec. 13, 2006.

(51) Int. Cl. B60G 11/00

(52) U.S. Cl. 254/10.5

(57) ABSTRACT

A hybrid spring extender is composed of a spring cup bonded to a urethane or polyurethane spacer. The spring cup is metal and may include one or more mechanical elements to secure the spring cup to the polyurethane spacer. The hybrid spring extender is installed between the spring and the frame element that normally secures the spring to increase lift, or the height of the vehicle frame from the pavement. The use of a metal spring cup protects the polyurethane from deformation, dissipates heat and spreads the load from the spring to the entire polyurethane spacer. The combination of metal spring cup and polyurethane spacer also minimizes noise and rotational forces on the spacer.

### RELATED APPLICATIONS

This application claims priority from copending U.S. Provisional patent application 60/874,784 filed Dec. 13, 2006.

### FIELD OF THE INVENTIONS

The inventions described below relate to the field of automobile accessories and more specifically to the field of aftermarket automobile suspension parts to provide vehicle lift.

### BACKGROUND OF THE INVENTIONS

When a vehicle owner seeks to increase the size of the tire and wheel on his or her vehicle one of the considerations is the size of the wheel wells in the vehicle and specifically the space in the front wheel wells as the front tires pivot to turn the vehicle. To increase the available space in a wheel well a typical solution is to lift the vehicle relative to the pavement with the wheel spindle farther from the top of the wheel well. This solution often results in changed suspension and or steering geometry that may have significant negative effects on the handling, performance and safety of the vehicle. These solutions may be complicated and difficult to install and align.

### SUMMARY

A hybrid spring extender is a simple, easy to install lift element that may be easily installed or removed from a vehicle to increase the vehicle lift and or permit the use of larger tires and wheels than originally provided on the vehicle. A hybrid spring extender is installed between a suspension spring and the frame element that normally secures the spring. Installation of a hybrid spring extender increases lift, the height of the vehicle frame from the pavement.

A hybrid spring extender is composed of a spring cup bonded to a urethane or polyurethane spacer. The spring cup is metal and may include one or more mechanical elements to secure the spring cup to the polyurethane spacer. The use of a metal spring cup protects the polyurethane from deformation, dissipates heat and spreads the load from the spring to the entire polyurethane spacer. The combination of metal spring cup and polyurethane spacer also minimizes noise and rotational forces on the spacer. The metal spring cup may also include one or more mechanical elements such as ribs, ridges and textures or other suitable devices to secure the spring within the spring cup.

Any suitable material may be used for the spacer such as polymers, urethane and or polyurethane. For most passenger automobile and truck applications, the selected spacer material should have a durometer reading of 100 on the A scale. Other readings on other scales may be suitable for other applications.

### BRIEF DESCRIPTION OF THE DRAWINGS

FIG. 1 is a side view of a suspension system with a hybrid spring extender.

FIG. 2 is a bottom view of a hybrid spring extender.

FIG. 3 is a side view of the hybrid spring extender of FIG. 2.

FIG. 4 is a cross section view of the polyurethane element of FIG. 2 taken along line A-A.

FIG. 5 is a cross section view of the spring cup element of FIG. 2 taken along line A-A.

FIG. 6 is a cross section view of the hybrid spring extender of FIG. 2 taken along line A-A.

### DETAILED DESCRIPTION OF THE INVENTIONS

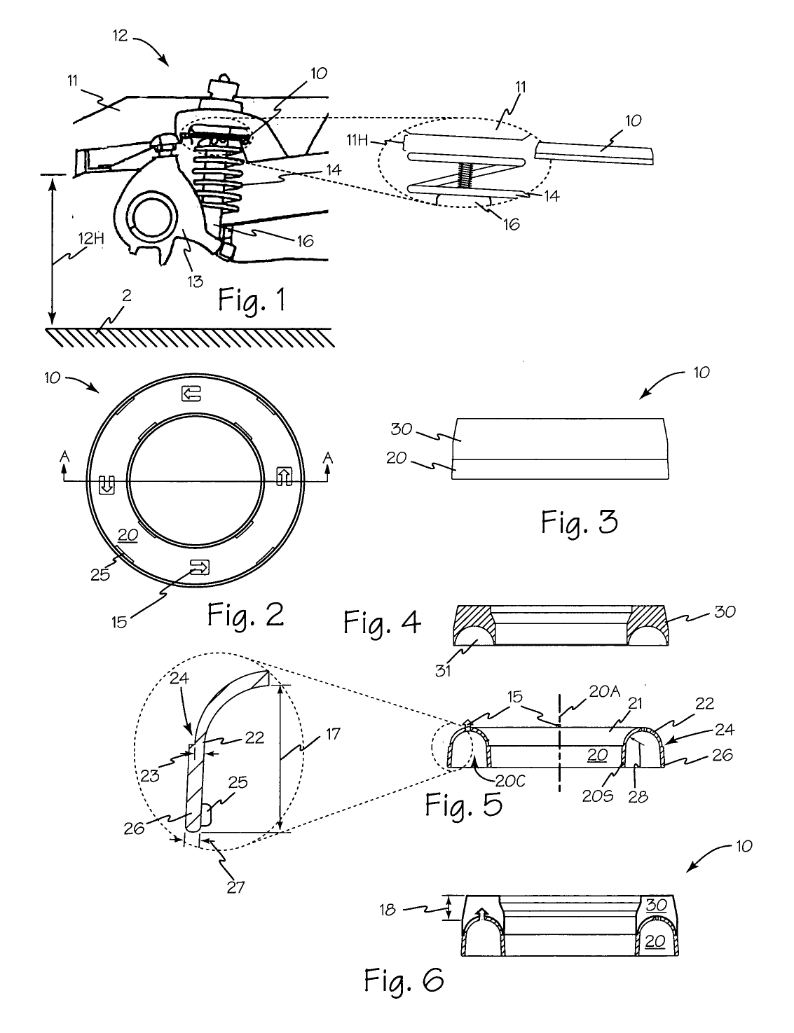

A portion of a vehicle suspension system is illustrated as suspension system 12 of FIG. 1. Suspension system 12 supports frame 11 above ground 2. Unsprung hub or axle 13 is separated from frame 11 by shock absorber 16 and coil spring 14 as shown. A hybrid spring extender such as spring extender 10 may increase the lift of spring 14 resulting in increased height 12H without changing the spring characteristics of spring 14.

Hybrid spring extender 10 is illustrated in FIG. 2 viewed from the spring side. Mechanical connectors 15 may be bent to extend into polyurethane spacer 30. In the side view of FIG. 3 spring cup 20 and polyurethane spacer 30 are shown combined as they would appear in FIG. 1.

Hybrid spring extender 10 includes spring cup 20 of FIG. 4 engaging polyurethane spacer 30 of FIG. 5 as shown in FIGS. 3 and 6. Spring cup is a semi-torus formed by rotating U-shaped section 20S around central axis 20A. Surface 31 of spacer 30 engages convex surface 21 of spring cup 20. Surface 21 may be prepared using any conventional technique to enhance the bond between spacer 30 and spring cup 20. Any suitable mechanical connections may be made between the polyurethane spacer and the spring cup such as mechanical connectors 15 to further secure spring cup 20 to spacer 30.

Spring cup 20 varies in thickness to further enhance the engagement of spacer 30. As shown in FIG. 5, thickness 23 at location 22 is smaller than thickness 27 at edge 26 to enable formation of shoulder 24 to form a secure demarcation between spacer 30 and spring cup 20 to further engage spacer 30.

Radius 28 may be selected to accommodate the radius of the steel forming spring 14. Depth 17 of a spring cup such as spring cup 20 may be selected to prevent spring 14 from unseating under use. Additionally, ribs, ridges and or other suitable mechanical elements and or texture may be formed on or attached to concave surface 20C of the spring cup to improve engagement of the spring cup to the spring. For example, ribs 25 may be included in spring cup 20 to secure spring 14 in the spring cup. Spring cup 20 may adopt any suitable internal geometry to suitably engage springs with different end characteristics. Some springs may be flat on the end, while others may have their coils cut at 90° angles. Spring cups may have internal shapes to suitably engage spring ends having any geometry.

As illustrated in FIG. 6, height 18 of spacer 30 combined with thickness 27 of spring cup 20 determines the height of lift available. Height 18 may be any suitable dimension.

In practice, a vehicle frame such as frame 11 may be raised using hybrid spring extenders 10 by disconnecting spring 14 and shock absorber 16 for each unsprung element such as hub 13 to create a space 11H between frame 11 and spring 14. Hybrid spring extender 10 may be inserted into space 11H to engage spring 14. Shock absorber 16 may be inserted through hybrid spring extender 10 and reconnected to frame 11 securing hybrid spring extender between spring 14 and frame 11. For the purposes of this example, frame includes elements such as spring cups and or other elements that may be distinguished from the frame in other contexts. Additionally, the spring extender may be inserted between the spring and the unsprung elements as an alternative or in addition to between the spring and the frame.

While the preferred embodiments of the devices and methods have been described in reference to the environment in which they were developed, they are merely illustrative of the principles of the inventions. Other embodiments and configurations may be devised without departing from the spirit of the inventions and the scope of the appended claims.

We claim:

1. A hybrid spring extender comprising:
a semi-torus spring cup having a concave surface for engaging a coil spring, and a convex surface for supporting a vehicle frame; and
a polyurethane pad bonded to the convex surface of the spring cup.

2. The hybrid spring extender of claim 1 further comprising:
a plurality of tabs extending from the spring cup into the polyurethane pad to mechanically engage the polyurethane pad to the spring cup.

3. The hybrid spring extender of claim 1 further comprising:
a plurality of ribs extending from the concave surface of the spring cup to mechanically engage the coil spring.

4. The hybrid spring extender of claim 1 further comprising:
a plurality of ridges extending from the concavesurface of the spring cup to mechanically engage the coil spring.

5. The hybrid spring extender of claim 1 further comprising:
a texture applied to the concave surface of the spring cup to mechanically engage the coil spring.

6. A method of raising the height of a vehicle frame supported above the ground by a plurality of unsprung elements supporting a plurality of spring and shock absorber combinations which connect to the frame, comprising the steps:
at each spring and shock absorber combination, loosen one or more connections between the frame and the unsprung elements to create space between the spring and the frame;
inserting a hybrid spring extender between the spring and the frame, the hybrid spring extender having a semi-torus spring cup with a concave surface for engaging the spring, and a convex surface for supporting a vehicle frame, and a polyurethane pad bonded to the convex surface of the spring cup for engaging the frame; and
securing the one or more connections between the frame and the unsprung elements previously loosened to create the space between the spring and the frame.
